(19) United States
(12) Patent Application Publication
(10) Pub. No.: US 2025/0291052 A1
(43) Pub. Date: Sep. 18, 2025

(54) MICROWAVE IMAGING WITH MULTIPLE-INPUT AND MULTIPLE-OUTPUT SYNTHETIC APERTURE RADAR USING COMPRESSED MULTI-COSET RANGE MIGRATION TECHNIQUE

(71) Applicant: Tata Consultancy Services Limited, Mumbai (IN)

(72) Inventors: Andrew GIGIE, Bengaluru (IN); Krishna Kanth ROKKAM, Bengaluru (IN); Achanna Anil KUMAR, Bengaluru (IN); Tapas CHAKRAVARTY, Kolkata (IN); Arpan PAL, Kolkata (IN)

(73) Assignee: Tata Consultancy Services Limited, Mumbai (IN)

(21) Appl. No.: 19/077,353

(22) Filed: Mar. 12, 2025

(30) Foreign Application Priority Data
Mar. 13, 2024 (IN) 202421018311

(51) Int. Cl. G01S 13/90

(52) U.S. Cl. CPC G01S 13/9021; G01S 13/9011; G01S 13/9056

(57) ABSTRACT

There is a need to address the problem of compressed scanning in SAR acquisitions for microwave imaging. Embodiments of the present disclosure provide microwave imaging with multiple-input and multiple-output synthetic aperture radar using compressed multi-coset range migration technique. The present disclosure reduces the SAR acquisition time by compressed scanning, where a compressed scanning acquisition setup captures radar measurements to obtain a microwave image of a target scene by intermittently skipping blocks during SAR acquisition. Further, reconstruction of a microwave image of a target scene is performed using 2D Fourier Transform (FT) of the radar measurements based on a multi-coset range-migration framework. The multi-coset range migration framework makes use of intermittent scanning and formulates a compressed sensing-based architecture by leveraging block-sparsity constraints. Subsequently, a denoising convolutional neural network (DnCNN) is used to enhance and denoise the reconstructed microwave image to obtain a high-resolution image of the target scene.

### PRIORITY CLAIM

This U.S. patent application claims priority under 35 U.S.C. § 119 to: Indian Patent Application number 202421018311, filed on 13 Mar. 2024. The entire contents of the aforementioned application are incorporated herein by reference.

### TECHNICAL FIELD

The disclosure herein generally relates to microwave image processing, and, more particularly, to method and system for microwave imaging with multiple-input and multiple-output synthetic aperture radar (MIMO-SAR) using compressed multi-coset range migration technique.

### BACKGROUND

Near-field microwave imaging is increasingly recognized as a viable alternative to existing imaging modalities such as X-ray. This recognition is due to its ability to penetrate range of materials, compact design, diminished health risks and cost effectiveness. Consequently, the near-field microwave imaging finds widespread application in various domains including concealed object detection, object/human tracking or identification, medical imaging, inspection of packed goods, through wall imaging, human robot interactions and/or the like. High resolution imaging is a key necessity in many of these applications. To fulfill this necessity, a Synthetic Aperture Radar (SAR) technique is typically employed which helps in improving the image resolution. Conventionally, a Single-Input and Single-Output (SISO) with the SAR (SISO-SAR) configuration is used where a single radar transmit-receive antenna pair is moved along a trajectory to synthetically increase the aperture. While SISO-SAR offers high resolution, but due to significant acquisition time, its practical deployment is restricted. On the other hand, millimeter-wave (mm-wave) MIMO radars are gaining popularity due to their compact designs and larger array dimensions. The integration of these MIMO radars with SAR motion (MIMO-SAR) has proven effective in significantly reducing the SAR acquisition time.

Typically, SAR reconstruction algorithms such as Back Projection Algorithm (BPA) and Range Migration (RMA) are employed on the collected measurements to reconstruct the SAR image of a scene. BPA is well known to be computationally intensive and hence is often not preferred in practice. In contrast, RMA relies on Fourier transform (FT) and utilizes Fast Fourier Transform (FFT) for efficient reconstruction. While RMA is computationally efficient, it requires uniform placement of array elements in MIMO radar, along with a consistent SAR trajectory. Further, in numerous application scenarios, there is a requirement to decrease the SAR measurements concurrently with the acquisition time, leading to a compressed scanning scenario. This makes it unsuitable for classical RMA.

There exists a compressed sensing (CS) paradigm-based approach, but it is computationally intensive. This is because the existing CS paradigm-based approach relies on Single Measurement Vector-compressed sensing (SMV-CS) based reconstruction, which involves operating on large dimensional measurement matrices. Further, a Non-Uniform FFT based RMA (NUFFT-RMA) has been used for image reconstruction, but this shows noticeable artifacts resulting in degraded SAR image reconstruction. Recently, a Multi-Coset sampling framework known as MC-RMA, is used that relaxes uniform array requirement of classical RMA. This framework demonstrates superior performance compared to NUFFT-RMA but does not address the compressed scanning scenario.

### SUMMARY

Embodiments of the present disclosure present technological improvements as solutions to one or more of the above-mentioned technical problems recognized by the inventors in conventional systems. For example, in one aspect, a processor implemented method is provided. The processor implemented method includes receiving, via one or more hardware processors, a plurality of back-scattered signals from a target scene as an input, wherein the plurality of back-scattered signals are received when at least one object at the target scene is scanned using a compressed scanning acquisition setup of a multiple input multiple output-synthetic aperture radar (MIMO-SAR) system to obtain a microwave image of the target scene, wherein the compressed scanning acquisition setup comprises an array of sensors that captures a plurality of measurements forming a plurality of intermittently skipped periodic blocks during scanning, and wherein the plurality of intermittently skipped periodic blocks are stitched to form a first aperture array; rearranging, via the one or more hardware processors, the plurality of back-scattered signals to generate a plurality of sub-arrays, wherein each of the plurality of sub-arrays is generated by combining a corresponding back-scattered signal received across each of a corresponding element of each period block from the plurality of intermittently skipped periodic blocks of the first aperture array; visualizing, via the one or more hardware processors, each of the plurality of sub-arrays as translated and decimated array of a second aperture array, wherein each sub-array element from a plurality of sub-array elements in each of the plurality of sub-arrays is uniformly spaced from each other; computing, via the one or more hardware processors, a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements; vectorizing, via the one or more hardware processors, the 2D FFT computed for the plurality of sub-array elements to obtain one or more vectorized sub-array matrices, wherein the one or more vectorized sub-array matrices are stacked to form one or more stacked sub-array matrices, wherein the one or more stacked sub-array matrices represent a weighted superposition of a stacked sub-band spectrum of the 2D FFT of the second aperture array using a precomputed weight matrix; reconstructing, via the one or more hardware processors, the microwave image of the target scene using the one or more stacked sub-array matrices, wherein the microwave image is reconstructed by applying one or more block-sparsity constraints on the one or more stacked sub-array matrices; and performing, via the one or more hardware processors, denoising on the reconstructed microwave image using a denoising convolutional neural network to obtain a final enhanced microwave image of the target scene.

In another aspect, there is provided a system. The system includes a memory storing instructions; one or more communication interfaces; and one or more hardware processors coupled to the memory via the one or more communication interfaces, wherein the one or more hardware processors are configured by the instructions to: receive a plurality of back-scattered signals from a target scene as an input, wherein the plurality of back-scattered signals are received when at least one object at the target scene is scanned using a compressed scanning acquisition setup of a multiple input multiple output-synthetic aperture radar (MIMO-SAR) system to obtain a microwave image of the target scene, wherein the compressed scanning acquisition setup comprises an array of sensors that captures a plurality of measurements forming a plurality of intermittently skipped periodic blocks during scanning, and wherein the plurality of intermittently skipped periodic blocks are stitched to form a first aperture array; rearrange the plurality of back-scattered signals to generate a plurality of sub-arrays, wherein each of the plurality of sub-arrays is generated by combining a corresponding back-scattered signal received across each of a corresponding element of each period block from the plurality of intermittently skipped periodic blocks of the first aperture array; visualize each of the plurality of sub-arrays as translated and decimated array of a second aperture array, wherein each sub-array element from a plurality of sub-array elements in each of the plurality of sub-arrays is uniformly spaced from each other; compute a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements; vectorize the 2D FFT computed for the plurality of sub-array elements to obtain one or more vectorized sub-array matrices, wherein the one or more vectorized sub-array matrices are stacked to form one or more stacked sub-array matrices, wherein the one or more stacked sub-array matrices represent a weighted superposition of a stacked sub-band spectrum of the 2D FFT of the second aperture array using a precomputed weight matrix; reconstruct the microwave image of the target scene using the one or more stacked sub-array matrices, wherein the microwave image is reconstructed by applying one or more block-sparsity constraints on the one or more stacked sub-array matrices; and perform denoising on the reconstructed microwave image using a denoising convolutional neural network to obtain a final enhanced microwave image of the target scene.

In yet another aspect, there are provided one or more non-transitory machine readable information storage mediums comprising one or more instructions which when executed by one or more hardware processors causes at least one of: receiving a plurality of back-scattered signals from a target scene as an input, wherein the plurality of back-scattered signals are received when at least one object at the target scene is scanned using a compressed scanning acquisition setup of a multiple input multiple output-synthetic aperture radar (MIMO-SAR) system to obtain a microwave image of the target scene, wherein the compressed scanning acquisition setup comprises an array of sensors that captures a plurality of measurements forming a plurality of intermittently skipped periodic blocks during scanning, and wherein the plurality of intermittently skipped periodic blocks are stitched to form a first aperture array; rearranging the plurality of back-scattered signals to generate a plurality of sub-arrays, wherein each of the plurality of sub-arrays is generated by combining a corresponding back-scattered signal received across each of a corresponding element of each period block from the plurality of intermittently skipped periodic blocks of the first aperture array; visualizing, each of the plurality of sub-arrays as translated and decimated array of a second aperture array, wherein each sub-array element from a plurality of sub-array elements in each of the plurality of sub-arrays is uniformly spaced from each other; computing a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements; vectorizing the 2D FFT computed for the plurality of sub-array elements to obtain one or more vectorized sub-array matrices, wherein the one or more vectorized sub-array matrices are stacked to form one or more stacked sub-array matrices, wherein the one or more stacked sub-array matrices represent a weighted superposition of a stacked sub-band spectrum of the 2D FFT of the second aperture array using a precomputed weight matrix; reconstructing the microwave image of the target scene using the one or more stacked sub-array matrices, wherein the microwave image is reconstructed by applying one or more block-sparsity constraints on the one or more stacked sub-array matrices; and performing denoising on the reconstructed microwave image using a denoising convolutional neural network to obtain a final enhanced microwave image of the target scene.

In accordance with an embodiment of the present disclosure, the first aperture array is a non-uniform entire aperture array having skipped data acquisition.

In accordance with an embodiment of the present disclosure, the second aperture array is a uniform entire aperture array without skipped data acquisition.

In accordance with an embodiment of the present disclosure, the precomputed weight matrix is obtained using a phase relationship of one or more spatial array elements across the stacked sub-band spectrum of the 2D FFT of the second aperture array.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates a system for microwave imaging with multiple-input and multiple-output synthetic aperture radar (MIMO-SAR) using compressed multi-coset range migration technique, according to some embodiments of the present disclosure.

FIG. 2 is an exemplary block diagram of the system of FIG. 1 implementing the MIMO-SAR for microwave imaging using compressed multi-coset range migration technique, according to some embodiments of the present disclosure.

FIG. 3 is an exemplary flow diagram illustrating method for microwave imaging with multiple-input and multiple-output synthetic aperture radar (MIMO-SAR) using compressed multi-coset range migration technique, according to some embodiments of the present disclosure.

FIG. 4 depicts a diagram illustrating structure of the one or more stacked sub-array matrix and the FT of the plurality of backscattered signal provided for a real test instance, according to some embodiments of the present disclosure.

FIG. 5 depicts exemplary graphical representation illustrating visual qualitative experimental results obtained by implementing prior art 1 (NUFFT-RMA), CMC-RMA, and the method of the present disclosure respectively for five instances from a test set according to an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

There is a need for an approach to address the problem of compressed scanning in SAR acquisitions for microwave imaging. Embodiments of the present disclosure provide a method and system for microwave imaging with multiple-input and multiple-output synthetic aperture radar (MIMO-SAR) using compressed multi-coset range migration technique. The microwave imaging corresponds but is not limited to (a) a near-field imaging, and (b) a far-field imaging. The approach of the present disclosure leverages compressed scanning to minimize the SAR acquisition time by intermittently skipping periodic blocks during SAR motion. Multiple smaller sub-arrays are formed by combining individual MIMO array elements across these scanned blocks. The sub-arrays are uniformly spaced due to the periodic skipping during SAR motion. The sub-array elements are further visualized as decimated and translated version of a uniform entire aperture array without skipped data acquisition, resembling a multi-coset sampling framework. Based on this visualization, a Fourier Transform (FT) of the sub-arrays and the FT of entire measurements are computed based on a Multiple Measurement Vector based compressed scanning (MMV-CS) recovery framework. The Fourier transform (FT) of entire measurements exhibits block-wise sparsity. Consequently, block sparsity constraints are incorporated into an optimization framework of the present disclosure to estimate the FT of the entire measurements. The estimated FT is then used to reconstruct microwave image of a scanned scene. A denoising step is performed based on Denoising Convolutional Neural Networks (DnCNNs) which are appropriately trained using collected data and are subsequently applied to further denoise and enhance the reconstructed SAR image, resulting in a final SAR image.

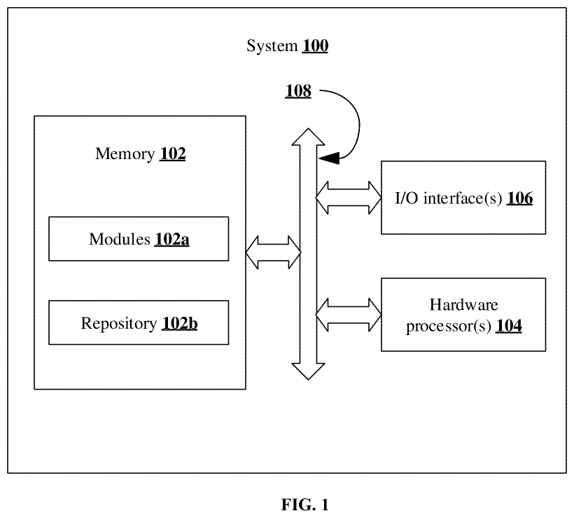

Referring now to the drawings, and more particularly to FIGS. 1 through 5, where similar reference characters denote corresponding features consistently throughout the figures, there are shown preferred embodiments and these embodiments are described in the context of the following exemplary system and/or method.

FIG. 1 illustrates a system 100 for microwave imaging with multiple-input and multiple-output synthetic aperture radar (MIMO-SAR) using compressed multi-coset range migration technique, according to an embodiment of the present disclosure. In an embodiment, the system 100 includes or is otherwise in communication with one or more hardware processors 104, communication interface device(s) or input/output (I/O) interface(s) 106, and one or more data storage devices or memory 102 operatively coupled to the one or more hardware processors 104. The one or more hardware processors 104, the memory 102, and the I/O interface(s) 106 may be coupled to a system bus 108 or a similar mechanism. The system 100 is further connected to a radar and antenna unit (Not shown in figure) via the I/O interface(s) 106.

The I/O interface(s) 106 may include a variety of software and hardware interfaces, for example, a web interface, a graphical user interface, and the like. The I/O interface(s) 106 may include a variety of software and hardware interfaces, for example, interfaces for peripheral device(s), such as a keyboard, a mouse, an external memory, a plurality of sensor devices, a printer and the like. Further, the I/O interface(s) 106 may enable the system 100 to communicate with other devices, such as web servers and external databases.

The I/O interface(s) 106 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 106 may include one or more ports for connecting a number of computing systems with one another or to another server computer. Further, the I/O interface(s) 106 may include one or more ports for connecting a number of devices to one another or to another server.

The one or more hardware processors 104 may be implemented as one or more microprocessors, microcomputers, microcontrollers, digital signal processors, central processing units, state machines, logic circuitries, and/or any devices that manipulate signals based on operational instructions. Among other capabilities, the one or more hardware processors 104 are configured to fetch and execute computer-readable instructions stored in the memory 102. In the context of the present disclosure, the expressions ‘processors’ and ‘hardware processors’ may be used interchangeably. In an embodiment, the system 100 can be implemented in a variety of computing systems, such as laptop computers, portable computer, notebooks, hand-held devices, workstations, mainframe computers, servers, a network cloud and the like.

The memory 102 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 102 includes a plurality of modules 102a and a repository 102b for storing data processed, received, and generated by one or more of the plurality of modules 102a. The plurality of modules 102a may include routines, programs, objects, components, data structures, and so on, which perform particular tasks or implement particular abstract data types.

The plurality of modules 102a may include programs or computer-readable instructions or coded instructions that supplement applications or functions performed by the system 100. The plurality of modules 102a may also be used as, signal processor(s), state machine(s), logic circuitries, and/or any other device or component that manipulates signals based on operational instructions. Further, the plurality of modules 102a can be used by hardware, by computer-readable instructions executed by the one or more hardware processors 104, or by a combination thereof. Further, the memory 102 may include information pertaining to input(s)/output(s) of each step performed by the processor(s) 104 of the system 100 and methods of the present disclosure.

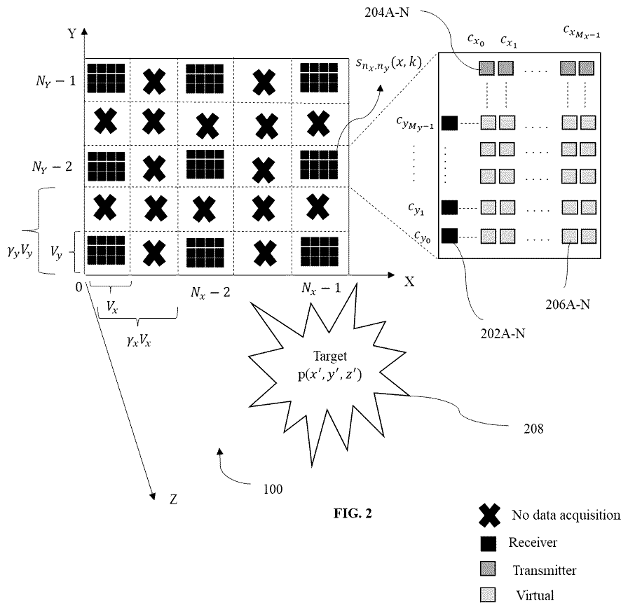

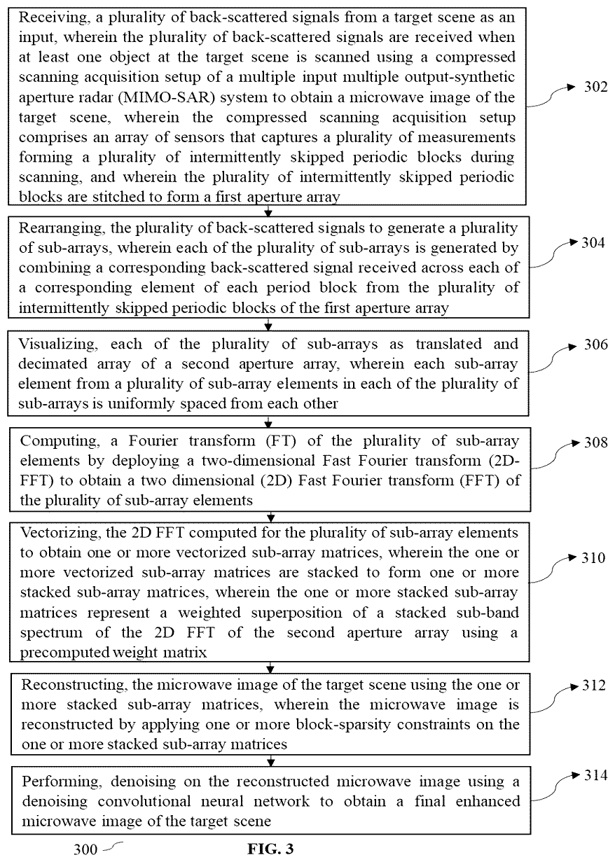

The repository 102b may include a database or a data engine. Further, the repository 102b amongst other things, may serve as a database or includes a plurality of databases for storing the data that is processed, received, or generated as a result of the execution of the plurality of modules 102a. Although the repository 102b is shown internal to the system 100, it will be noted that, in alternate embodiments, the repository 102b can also be implemented external to the system 100, where the repository 102b may be stored within an external database (not shown in FIG. 1) communicatively coupled to the system 100. The data contained within such external database may be periodically updated. For example, new data may be added into the external database and/or existing data may be modified and/or non-useful data may be deleted from the external database. In one example, the data may be stored in an external system, such as a Lightweight Directory Access Protocol (LDAP) directory and a Relational Database Management System (RDBMS). In another embodiment, the data stored in the repository 102b may be distributed between the system 100 and the external database. Functions of the components of the system 100 are now explained with reference to architecture as depicted in steps in flow diagrams in FIG. 2 and FIG. 3.

FIG. 2 is an exemplary block diagram of the system 100 of FIG. 1 implementing the MIMO-SAR for the microwave imaging, according to an embodiment of the present disclosure. The system 100 includes the multiple-input and multiple-output (MIMO) radar and a synthetic aperture radar (SAR) i.e., the MIMO-SAR. The MIMO radar includes one or more receivers 202A-N, one or more transmitters 204A-N, one or more virtual elements 206A-N, and a target scene 208. The MIMO-SAR with a linear array of receivers 202A-N and the one or more transmitters 204A-N are placed orthogonally which provides a rectangular array of Mₓ×M_{y} virtual array elements 206A-N. In an embodiment, the MIMO radar corresponds to a two-dimensional (2D) MIMO radar. The position of these virtual array elements is denoted by C=Cₓ×C_{y}, where ‘×’ denotes cartesian product of two sets and

$${C}_{x} = \{ {c}_{{x}_{0}} , {c}_{{x}_{1}} , … {c}_{{x}_{{M}_{x} - 1}} \} , and \\ {C}_{y} = \{ {c}_{{y}_{0}} , {c}_{{y}_{1}} , … {c}_{{y}_{{M}_{y} - 1}} \} ,$$

represent position of transmitter and receiver elements respectively.

FIG. 3, with reference to FIGS. 1 and 2, is an exemplary flow diagram illustrating method for microwave imaging with multiple-input and multiple-output synthetic aperture radar (MIMO-SAR) using compressed multi-coset range migration technique, according to an embodiment of the present disclosure. Referring to FIG. 3, in an embodiment, the system(s) 100 comprises one or more data storage devices or the memory 102 operatively coupled to the one or more hardware processors 104 and is configured to store instructions for execution of steps of the method by the one or more processors 104. The steps of the method 200 of the present disclosure will now be explained with reference to components of the system 100 of FIG. 1, the flow diagram as depicted in FIG. 2, and one or more examples. Although steps of the method 300 including process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any practical order. Further, some steps may be performed simultaneously, or some steps may be performed alone or independently.

In an embodiment, at step 302 of the present disclosure, the one or more hardware processors 104 are configured to receive a plurality of back-scattered signals from a target scene as an input. The plurality of back-scattered signals are received when at least one object at the target scene is scanned using a compressed scanning acquisition setup of a multiple input multiple output-synthetic aperture radar (MIMO-SAR) system to obtain a microwave image of the target scene. The received plurality of back-scattered signals for an array element located at x=(x, y) can be expressed as s (x, k):

$$s ( x , k ) = \int \int \int ρ ( {x}^{′} , {y}^{′} , {z}^{′} ) {e}^{- j 2 k R} dxdydz \qquad ( 1 )$$

where p(x′, y′, z′) denote a three-dimensional (3D) target reflectivity function of the target scene 208, R is distance between the array element and one or more points of the target scene 208 in the three-dimension (3D), and k denotes a wave number. Here, the spherical waves are assumed as superposition of planar waves and approximate e^{-j2kR} as:

$${e}^{- j 2 k R} ≃ \int \int {e}^{- j ( {k}_{x} ( {x}^{′} - x ) + {k}_{y} ( {y}^{′} - y ) + {k}_{z} ( {Z}_{0} - z ) )} d {k}_{x} d {k}_{y} \qquad ( 2 )$$

Here, kₓ, k_{y}, and k_{z} represent the wave numbers along the x, y, and z axes, respectively and Z₀ signifies a distance along the z dimension between scanning and target planes.

The compressed scanning acquisition setup comprises an array of sensors that captures a plurality of measurements forming a plurality of intermittently skipped periodic blocks during scanning. The plurality of intermittently skipped periodic blocks are stitched to form a first aperture array. As shown in FIG. 2, the first aperture array is a non-uniform entire aperture array having skipped data acquisition. For compressed scanning, intermittent periodic skips are incorporated in contrast to uniform SAR motion where the MIMO radar moves in uniform blocks. The compressed scanning acquisition setup not only expediates SAR acquisition time but also helps to reduce computational complexity owing to lesser data and is easily realizable in practice. The plurality of measurements denoted by s(x, k) captured by the array of sensors are expressed as follows:

$${s}_{{n}_{x} , {n}_{y}} ( x , k ) = s ( {n}_{x} {γ}_{x} {V}_{x} + {C}_{x} , {n}_{y} {γ}_{y} {V}_{y} + {C}_{y} , k ) \qquad ( 3 )$$

Here, Vₓ=c_{xM}_{ₓ}₋₁+cₓ_{₁}, V_{y}=c_{yM}_{_{y}}₋₁+c_{y}_{₁}, γₓ>1, γ_{y}>1 denotes the skip factors along x and y dimensions respectively. The parameters Nₓ and N_{y} denote the number of periodic block scans along the x and y axis respectively, and 0≤nₓ≤Nₓ−1, 0≤n_{y}≤N_{y}−1.

Further, at step 304 of the present disclosure, the one or more hardware processors 104 are configured to rearrange the plurality of back-scattered signals to generate a plurality of sub-arrays. Each of the plurality of sub-arrays is generated by combining a corresponding back-scattered signal received across each of a corresponding element of each period block from the plurality of intermittently skipped periodic blocks of the first aperture array. This rearrangement for generating the plurality of sub-arrays is referred as a multi-coset based formulation where multiple smaller sub-arrays represented by sₗ_{ₓ}ₗ_{_{y}}(x, k) corresponding to lₓ^{th}, lₓ^{th} elements of all the sₙ_{ₓ},ₙ_{_{y}}(x, k) blocks is provided as:

$${s}_{{l}_{x} , {l}_{y}} ( x , k ) = s ( Dx + {c}_{{l}_{x} , {l}_{y}} , k ) \qquad ( 4 )$$

Here 0≤lₓ≤Mₓ−1, 0≤l_{y}≤M_{y}−1,

$${c}_{{l}_{x} , {l}_{y}} = {[ {c}_{{x}_{{l}_{x}}} , {c}_{{y}_{{l}_{y}}} ]}^{T}$$

and the factor D=diag {Dₓ, D_{y}}, where Dₓ=γₓMₓ and D_{y}=γ_{y}M_{y}. It is observed that the array elements in sₙ_{ₓ}_{,n}_{_{y}}(x, k) are non-uniform, but the sensor elements in the plurality of sub-arrays s_{lx,ly}(x, k) for any lₓ, l_{y} are uniformly spaced due to 2-D periodic skipping.

At step 306 of the present disclosure, the one or more hardware processors 104 are configured to visualize each of the plurality of sub-arrays as translated and decimated array of a second aperture array. The second aperture array is a uniform entire aperture array without skipped data acquisition. Here, each sub-array element from a plurality of sub-array elements in each if the plurality of sub-arrays is uniformly spaced from each other. This means that the sub-array elements provided in equation (4) can be visualized as decimated and translated arrays of the uniform entire aperture array without skipped data acquisition as shown in FIG. 2, and closely resembles a multi-coset sampling structure.

Further, at step 308 of the present disclosure, the one or more hardware processors 104 are configured to compute a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements. Further, at step 310 of the present disclosure, the one or more hardware processors 104 are configured to vectorize the 2D FFT computed for the plurality of sub-array elements to obtain one or more vectorized sub-array matrices. The one or more vectorized sub-array matrices are stacked to form one or more stacked sub-array matrices. The one or more stacked sub-array matrices represent a weighted superposition of stacked sub band spectrum of the 2D FFT of the second aperture array using a precomputed weight matrix.

In an embodiment, the steps 308 and 310 are better understood by way of the following description provided as exemplary explanation.

In a traditional Range Migration Algorithm (RMA) which is used to reconstruct the 3D target reflectivity function p(x′, y′, z′) from the acquired s(x, k). By substituting (2) into (1) and applying 2-D FT, the FT of the plurality of backscattered signal are expressed as:

$$S ( {k}_{x} , k ) = P ( {k}_{x} , {k}_{z} ) {e}^{j {k}_{z} {Z}_{0}} \qquad ( 5 )$$

Here, kₓ=(kₓ, k_{y}) and should satisfy below expression:

$${k}_{z} = \sqrt{4 {k}^{2} - {k}_{x}^{2} - {k}_{y}^{2}} , {k}_{x}^{2} + {k}_{y}^{2} \leq 4 {k}^{2} \qquad ( 6 )$$

A final 2-D target reflectivity function p(x′, y′) at plane z′=Z₀ can be obtained from equation (5) using the following expression:

$$ρ ( {x}^{′} , {y}^{′} ) = {IFT}_{2 D}^{( {k}_{x} , {k}_{y} )} [ {e}^{- j {k}_{z} {Z}_{0}} S ( {k}_{x} , k ) ] \qquad ( 7 )$$

Here, IFT_{2D} represents the two-dimensional inverse FT. In order to estimate, p(x′, y′) from equation (7), the FT represented as S(k_{y}, k) is necessary. Traditionally, S(kₓ, k) is computed from s(x, k) using a standard 2D FFT, where the MIMO radar is scanned uniformly along x. This results in an increase in both SAR measurements as well as the scan duration. It is observed that S(kₓ, k) cannot be directly estimated from equation (3) using the standard 2D-FFT.

The 2-D FFT is applied on sₗ_{ₓ}_{,l}_{_{y}}(x, k) to compute an aliased FT sₗ_{ₓ}_{,l}_{_{y}}(kₓ, k) which is expressed as:

$${S}_{{l}_{x} , {l}_{y}} ( {k}_{x} , k ) = \frac{1}{{D}_{x} {D}_{y}} {e}^{- j 2 π {c}_{{l}_{x} , {l}_{y}} {k}_{x}} {\sum }_{q = 0}^{\vert Λ \vert} {e}^{j 2 π {c}_{{l}_{x} , {l}_{y}} {D}^{- 1} {λ}_{q}} S ( {k}_{x} + {D}^{- 1} {λ}_{q} , k ) \qquad ( 8 )$$

where λ_{q} denotes q^{th} element of a set Λ={0, 1, . . . , Dₓ−1}×{0, 1, . . . , D_{y}−1}. The S(kₓ, k) denotes the 2D FFT of the second aperture array. The 2D FFT of the one or more sub-array elements is vectorized to obtain one or more vectorized sub-array matrices. (kₓ+D⁻¹λ_{q}, k) in equation (8) denotes the one or more vectorized sub-array matrices (also referred as non-overlapping sub-band patches) of S(kₓ, k) of dimension Nₓ×N_{y} beginning from the position diag{Nₓ, N_{y}}λ_{q}. The one or more vectorized sub-array matrices are stacked to form one or more stacked sub-array matrices which are represented as:

$${S}_{s b} ( {k}_{x} , k ) {=}^{Δ} {[ ( S ( {k}_{x} + {D}^{- 1} {λ}_{0} , k ) , S ( {k}_{x} + {D}^{- 1} {λ}_{1} , k ) , … S ( {k}_{x} + {D}^{- 1} {λ}_{\vert Λ \vert} , k ) ]}^{T} \qquad ( 9 )$$

$${S}_{l} ( {k}_{x} , k ) {=}^{Δ} {[ {S}_{0 , 0} ( {k}_{x} , k ) , {S}_{0 , 1} ( {k}_{x} , k ) , … {S}_{{M}_{x - 1} , {M}_{y - 1}} ( {k}_{x} , k ) ]}^{T} \\ Δ ( {k}_{x} ) {=}^{Δ} diag \{ {e}^{- j 2 π {c}_{0 , 0} {k}_{x}} , {e}^{- j 2 π {c}_{0 , 1} {k}_{x}} , … , {e}^{- j 2 π {c}_{{M}_{x} - 1 , {M}_{y} - 1} {k}_{x}} \} \qquad ( 10 )$$

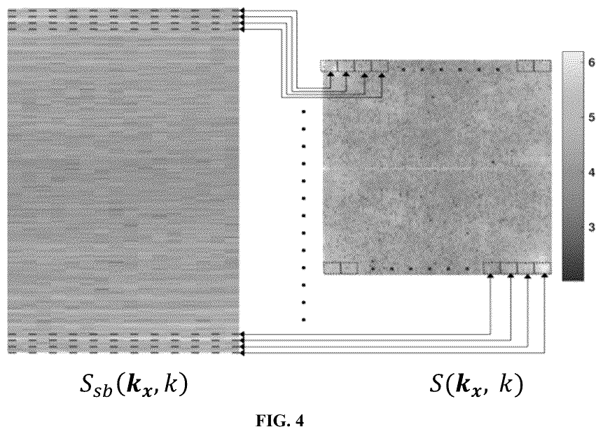

FIG. 4 depicts a diagram illustrating structure of the one or more stacked sub-array matrices S_{sb}(k_{y}, k) and the FT of the plurality of backscattered signal S(kₓ, k) provided for a real test instance, according to some embodiments of the present disclosure. The one or more stacked sub array matrices are relatively equivalent to a weighted superposition of a stacked sub band spectrum of the 2D FFT of the second aperture array using a precomputed weight matrix, and can be expressed as:

$${S}_{l} ( {k}_{x} , k ) = \frac{1}{{D}_{x} {D}_{y}} Δ ( {k}_{x} ) {AS}_{s b} ( {k}_{x} , k ) \qquad ( 11 )$$

A is a matrix of size Mₓ M_{y}×Dₓ D_{y} and represents the precomputed weight matrix. Any (l, q) element of A is given as

$${[ A ]}_{l , q} = {e}^{j 2 π {c}_{{l}_{x} , {l}_{y}}^{T} {D}^{- 1} {λ}_{q}} .$$

The precomputed weight matrix is using a phase relationship of one or more spatial array elements across the stacked sub-band spectrum of the 2D FFT of the second aperture array.

Referring to FIG. 3, at step 312 of the present disclosure, the one or more hardware processors 104 are configured to reconstruct a microwave image of the target scene using the one or more stacked sub-array matrices. The microwave image is reconstructed by applying one or more block-sparsity constraints on the one or more stacked sub-array matrices. It is observed from equation (11) that S_{sb} is unknown, while Sₗ is known and the matrices Δ(kₓ), and A are pre-computed. The equation (11) is simplified and expressed as:

$$y = A {S}_{s b} \qquad ( 12 )$$

where y=DₓD_{y}(Δ(kₓ))⁻¹Sₗ (kₓ, k) and S_{sb}=S_{sb}(kₓ, k).
   It is observed from FIG. 4 that S_{sb} exhibits row-wise sparsity. This means that only few rows of S_{sb} contains significant energy. Hence inorder to recover S_{sb}, the one or more block-sparsity constraints are applied in equation (12) and are expressed as:

$${S}_{s b} = arg {min}_{{S}_{s b}} {‖ y - {AS}_{s b} ‖}_{F}^{2} + β {‖ {S}_{s b} ‖}_{2 , 1} \qquad ( 13 )$$

Here, [symbol] _{2,1} norm is defined as ∥S_{sb}∥_{2,1}=Σ_{q=1}^{D}^{ₓ}^{D}^{_{y}}{square root over (Σₚ₌₁^{N}^{ₓ}^{N}^{_{y}}(S_{sb})_{p.q})} and (S_{sb})_{p.q} denotes (p, q)^{th} element of the matrix S_{sb}. It is observed that equation (13) resembles the MMV-CS reconstruction framework. To obtain S_{sb} from equation (13), any existing MMV-CS recovery algorithm can be used. However, and in the present disclosure, a proximal gradient approach which involves the following alternative gradient descent and soft thresholding iterations on each of the q blocks are used. The closed form update for the (t+1)^{th} iterative is shown below in equations (14) and (15):

$${( {S}_{s b} )}_{q}^{( t + 1 )} = {( {S}_{s b} )}_{q}^{( t )} + α {A}^{T} ( y - {AS}_{sb}^{( t )} ) \qquad ( 14 )$$

$${( {S}_{s b} )}_{q}^{( t + 1 )} = {( {S}_{s b} )}_{q}^{( t + 1 )} {( 1 - β / {‖ {S}_{s b} ‖}_{2} )}_{+} \qquad ( 15 )$$

Here (.)₊ indicates max (., 0), α is a learning rate and β is a thresholding hyperparameter that is used to control degree of sparsity. After tuning, it is observed that the above closed-form updates converge within 5 iterations. Additionally, the unrolling of these iterative steps can be employed which results in greatly reducing the reconstruction duration. After obtaining S_{sb}(kₓ, k), the non-overlapping sub-bands can be appropriately rearranged as shown in FIG. 4 to obtain S(kₓ, k). Further, S(kₓ, k) is inserted into a classical RMA algorithm to obtain the two-dimensional target reflectivity function p(x′, y′). The dimension of the measurement matrix A in the present disclosure is Mₓ M_{y}×Dₓ D_{y} and the gradient descent step. A significant reduction in the matrix dimension of A is observed which leads to a significant computational improvement.

Further, at step 312 of the present disclosure, the one or more hardware processors 104 are configured to perform denoising on the reconstructed microwave image using a denoising convolutional neural network to obtain a final enhanced microwave image of the target scene. The reconstructed microwave image is fed to the denoising convolutional neural network (DnCNN) for denoising. The denoising convolutional neural network is known to be capable of learning denoising filters from images while preserving image details. A (typical) DnCNN comprises a network architecture and a model learning from data. In designing the network architecture, a structure that comprise of multiple convolutional and batch normalization layers is adopted making it suitable for SAR image denoising. For the model learning part, a residual learning strategy is employed wherein the network learns to predict the noise given a noisy SAR image. Let the reconstructed microwave image p(x′, y′) be denoted as p for simplicity. The ground truth image is denoted as s is obtained using complete scan s(x, k) which means γₓ=1, γ_{y}=1; without any skipping between the MIMO-SAR acquisitions. The task here is to recover ground truth (s) for a given image. Here {(pᵢ, sᵢ)}ᵢ₌₁^{N} represents N {compressed sensing multi coset range migration algorithm (CMC-RMA), ground truth} training image pairs. It is assumed that CMC-RMA image follows a degradation model, pᵢ=sᵢ+vᵢ, where, the component of represents artifacts created in CMC-RMA image reconstruction. In DnCNN, a residual mapping E(pᵢ; θ)≈vᵢ is trained to be learnt to obtain a denoised image sᵢ=pᵢ−E(pᵢ; θ). The mean squared error (MSE) between predicted residual images (E) and actual artifacts in CMC-RMA images (vᵢ) is employed as a loss function to optimize the trainable parameters θ as shown below:

$$l ( θ ) = \frac{1}{2 N} {\sum }_{i = 1}^{N} {‖ E ( {ρ}_{i} ; θ ) - ( {ρ}_{i} - {s}_{i} ) ‖}_{F}^{2} \qquad ( 16 )$$

After suitably training the DnCNN, the trained network is deployed to denoise the SAR image generated using CMC-RMA to obtain a final denoised SAR image which is the final enhanced microwave image of the target scene.

### Experimental Results

In an embodiment, experimental results have been obtained to validate effectiveness of the method of the present disclosure in comparison to state-of-the-art techniques. The plurality of measurements was obtained using an imagevk-74 Radar which is a Stepped Frequency Continuous Wave (SFCW) MIMO radar, by mounting it on a 2-D mechanical scanner. The targets were placed within a box and kept at a distance of Z₀=20 cm. The MIMO radar operated within a frequency range of (62-69) GHz and collected the frequency response for 150 points. The MIMO array with Mₓ=20 transmit antennas and M_{y}=20 receive antennas were positioned orthogonally to form a rectangular virtual array with dimensions Mₓ×M_{y}. Inter-element distance between array elements is 2 mm, thus Vₓ=40 mm, V_{y}=40 mm. Further, the compressed scanning has been obtained by skipping periodic intermittent blocks with γₓ=1.25, γ_{y}=1.25, Nₓ=4 and N_{y}=4. With this experimental configuration, the dimensions of sₙ_{ₓ}_{,n}_{_{y}}(x, k), sₗ_{ₓ}_{,l}_{_{y}}(x,k), and s(x, k) are 20×20, 4×4, and 100×100 respectively, for a given k.

In the present disclosure, data has been collected for 70 instances by placing commonly-used objects such as knife, cutting plier, metal plates, coins, mobile phones, coke cans, and/or the like. Hyperparameters α=1e−3 and β=5e3 of the method of the present disclosure were tuned using grid search. Further 60 images were used for training the DnCNN network and the remaining were used for evaluating the reconstruction performance. Standard augmentation techniques such as rotation, circular shift was applied on the training data and 128 random patches were extracted from each image. Hence in total around 10,000 patches of size 50×50 were used for training the DnCNN network for 100 epochs. An Adam optimizer is used with weight decay of 0.0001, a momentum of 0.9 and a mini-batch size of 64. The network depth is set to 8 and MSE loss (i.e., (16)) is adopted to learn residual mapping.

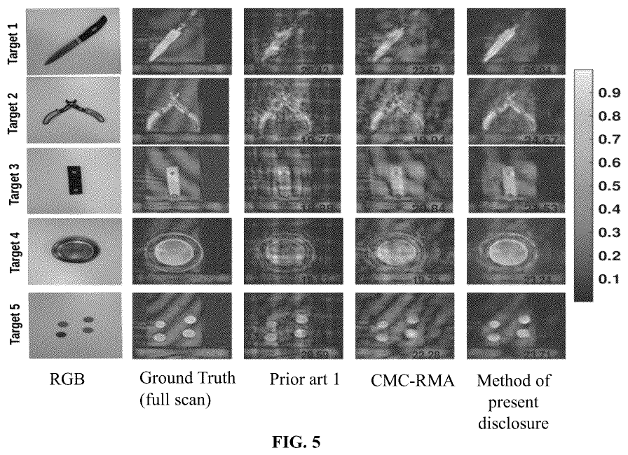

FIG. 5 depicts exemplary graphical representation illustrating visual qualitative experimental results obtained by implementing prior art 1 (NUFFT-RMA), CMC-RMA, and the method of the present disclosure respectively for five instances from a test set according to an embodiment of the present disclosure. As shown in FIG. 5, the ground truth image which is obtained using complete scan (i.e., without any skipping between the MIMO-SAR acquisitions) and state of the art methods employ the compressed scanning framework It is also shown in FIG. 5 that the SAR image obtained using a prior art 1 (i.e., NUFFT-RMA) shows artifacts and results in poorer reconstruction. These artifacts are effectively mitigated using the compressed sensing multi coset range migration algorithm (i.e., CMC-RMA) reconstruction as shown in FIG. 5, leading to noticeable improvement in resulting image. Subsequently, the trained DnCNN further denoises the image obtained from CMC-RMA providing a superior reconstruction. A quantitative comparison between the state-of-the-art methods and the method of present disclosure is provided in Table 1.

TABLE 1

| | Prior | | Method of the present disclosure |
|---|---|---|---|
| | art 1 | CMC-RMA | (CMC-RMA + DnCNN) |
| PSNR (dB) | 18.94 | 20.13 | 23.44 |
| SSIM | 0.52 | 0.54 | 0.62 |

In Table 1, averaged peak signal-to-noise ratio (PSNR) and structural similarity index measure (SSIM) values across all test cases are reported. It is observed that the method of present disclosure combining CMC-RMA and DnCNN exhibits an improvement of close to 4 dB and 0.1 in PSNR and SSIM respectively compared to the prior art 1 (i.e., NUFFT-RMA).

There is a need to address the problem of compressed scanning in SAR acquisitions for microwave imaging. Embodiments of the present disclosure provide method and system for microwave imaging with multiple-input and multiple-output (MIMO) synthetic aperture radar (SAR). The present disclosure reduces the SAR acquisition time by compressed scanning, where a compressed scanning acquisition setup captures radar measurements by intermittently skipping blocks during SAR acquisition. Further, reconstruction of a microwave image of a target scene is performed using 2D Fourier Transform (FT) of the radar measurements based on a multi-coset framework. The multi-coset framework makes use of intermittent scanning and formulates a compressed sensing-based framework by leveraging block-sparsity constraints. Subsequently, a denoising convolutional neural network (DnCNN) is used to enhance and denoise the reconstructed microwave image to obtain a high-resolution image of the target scene. Both the quantitative and qualitative results on real experimental data for the present disclosure demonstrate substantial improvement over existing state-of-art approaches. The method of the present disclosure not only expediates the scanning but also offers computational and performance advantages over conventional methods.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means, and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, a plurality of back-scattered signals from a target scene as an input, wherein the plurality of back-scattered signals are received when at least one object at the target scene is scanned using a compressed scanning acquisition setup of a multiple input multiple output-synthetic aperture radar (MIMO-SAR) system to obtain a microwave image of the target scene, wherein the compressed scanning acquisition setup comprises an array of sensors that captures a plurality of measurements forming a plurality of intermittently skipped periodic blocks during scanning, and wherein the plurality of intermittently skipped periodic blocks are stitched to form a first aperture array;
rearranging, via the one or more hardware processors, the plurality of back-scattered signals to generate a plurality of sub-arrays, wherein each of the plurality of sub-arrays is generated by combining a corresponding back-scattered signal received across each of a corresponding element of each period block from the plurality of intermittently skipped periodic blocks of the first aperture array;
visualizing, via the one or more hardware processors, each of the plurality of sub-arrays as translated and decimated array of a second aperture array, wherein each sub-array element from a plurality of sub-array elements in each of the plurality of sub-arrays is uniformly spaced from each other;
computing, via the one or more hardware processors, a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements;
vectorizing, via the one or more hardware processors, the 2D FFT computed for the plurality of sub-array elements to obtain one or more vectorized sub-array matrices, wherein the one or more vectorized sub-array matrices are stacked to form one or more stacked sub-array matrices, wherein the one or more stacked sub-array matrices represent a weighted superposition of a stacked sub-band spectrum of the 2D FFT of the second aperture array using a precomputed weight matrix;
reconstructing, via the one or more hardware processors, the microwave image of the target scene using the one or more stacked sub-array matrices, wherein the microwave image is reconstructed by applying one or more block-sparsity constraints on the one or more stacked sub-array matrices; and
performing, via the one or more hardware processors, denoising on the reconstructed microwave image using a denoising convolutional neural network to obtain a final enhanced microwave image of the target scene.

2. The processor implemented method (of claim 1, wherein the first aperture array is a non-uniform entire aperture array having skipped data acquisition.

3. The processor implemented method of claim 1, wherein the second aperture array is a uniform entire aperture array without skipped data acquisition.

4. The processor implemented method of claim 1, wherein the precomputed weight matrix is obtained using a phase relationship of one or more spatial array elements across the stacked sub-band spectrum of the 2D FFT of the second aperture array.

5. A system, comprising:
a memory storing instructions;
one or more communication interfaces; and
one or more hardware processors coupled to the memory via the one or more communication interfaces, wherein the one or more hardware processors are configured by the instructions to:
receive a plurality of back-scattered signals from a target scene as an input, wherein the plurality of back-scattered signals are received when at least one object at the target scene is scanned using a compressed scanning acquisition setup of a multiple input multiple output-synthetic aperture radar (MIMO-SAR) system to obtain a microwave image of the target scene, wherein the compressed scanning acquisition setup comprises an array of sensors that captures a plurality of measurements forming a plurality of intermittently skipped periodic blocks during scanning, and wherein the plurality of intermittently skipped periodic blocks are stitched to form a first aperture array;
rearrange the plurality of back-scattered signals to generate a plurality of sub-arrays, wherein each of the plurality of sub-arrays is generated by combining a corresponding back-scattered signal received across each of a corresponding element of each period block from the plurality of intermittently skipped periodic blocks of the first aperture array;
visualize each of the plurality of sub-arrays as translated and decimated array of a second aperture array, wherein each sub-array element from a plurality of sub-array elements in each of the plurality of sub-arrays is uniformly spaced from each other;
compute a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements;
vectorize the 2D FFT computed for the plurality of sub-array elements to obtain one or more vectorized sub-array matrices, wherein the one or more vectorized sub-array matrices are stacked to form one or more stacked sub-array matrices, wherein the one or more stacked sub-array matrices represent a weighted superposition of a stacked sub-band spectrum of the 2D FFT of the second aperture array using a precomputed weight matrix;
reconstruct the microwave image of the target scene using the one or more stacked sub-array matrices, wherein the microwave image is reconstructed by applying one or more block-sparsity constraints on the one or more stacked sub-array matrices; and
perform denoising on the reconstructed microwave image using a denoising convolutional neural network to obtain a final enhanced microwave image of the target scene.

6. The system of claim 5, wherein the first aperture array is a non-uniform entire aperture array having skipped data acquisition.

7. The system of claim 5, wherein the second aperture array is a uniform entire aperture array without skipped data acquisition.

8. The system of claim 5, wherein the precomputed weight matrix is obtained using a phase relationship of one or more spatial array elements across the stacked sub-band spectrum of the 2D FFT of the second aperture array.

9. One or more non-transitory machine-readable information storage mediums comprising one or more instructions which when executed by one or more hardware processors cause:
receiving a plurality of back-scattered signals from a target scene as an input, wherein the plurality of back-scattered signals are received when at least one object at the target scene is scanned using a compressed scanning acquisition setup of a multiple input multiple output-synthetic aperture radar (MIMO-SAR) system to obtain a microwave image of the target scene, wherein the compressed scanning acquisition setup comprises an array of sensors that captures a plurality of measurements forming a plurality of intermittently skipped periodic blocks during scanning, and wherein the plurality of intermittently skipped periodic blocks are stitched to form a first aperture array;
rearranging the plurality of back-scattered signals to generate a plurality of sub-arrays, wherein each of the plurality of sub-arrays is generated by combining a corresponding back-scattered signal received across each of a corresponding element of each period block from the plurality of intermittently skipped periodic blocks of the first aperture array;
visualizing each of the plurality of sub-arrays as translated and decimated array of a second aperture array, wherein each sub-array element from a plurality of sub-array elements in each of the plurality of sub-arrays is uniformly spaced from each other;
computing a Fourier transform (FT) of the plurality of sub-array elements by deploying a two-dimensional Fast Fourier transform (2D-FFT) to obtain a two-dimensional (2D) Fast Fourier transform (FFT) of the plurality of sub-array elements;
vectorizing the 2D FFT computed for the plurality of sub-array elements to obtain one or more vectorized sub-array matrices, wherein the one or more vectorized sub-array matrices are stacked to form one or more stacked sub-array matrices, wherein the one or more stacked sub-array matrices represent a weighted superposition of a stacked sub-band spectrum of the 2D FFT of the second aperture array using a precomputed weight matrix;
reconstructing the microwave image of the target scene using the one or more stacked sub-array matrices, wherein the microwave image is reconstructed by applying one or more block-sparsity constraints on the one or more stacked sub-array matrices; and
performing denoising on the reconstructed microwave image using a denoising convolutional neural network to obtain a final enhanced microwave image of the target scene.

10. The one or more non-transitory machine-readable information storage mediums of claim 9, wherein the first aperture array is a non-uniform entire aperture array having skipped data acquisition.

11. The one or more non-transitory machine-readable information storage mediums of claim 9, wherein the second aperture array is a uniform entire aperture array without skipped data acquisition.

12. The one or more non-transitory machine-readable information storage mediums of claim 9, wherein the precomputed weight matrix is obtained using a phase relationship of one or more spatial array elements across the stacked sub-band spectrum of the 2D FFT of the second aperture array.
